(19) United States
(12) Patent Application Publication
(10) Pub. No.: US 2022/0209360 A1
(43) Pub. Date: Jun. 30, 2022

(54) FILM-TYPE BATTERY

(71) Applicant: Prime Planet Energy & Solutions, Inc., Tokyo (JP)

(72) Inventor: Satoshi NAKASHIMA, Toyota-shi (JP)

(21) Appl. No.: 17/557,080

(22) Filed: Dec. 21, 2021

(30) Foreign Application Priority Data
Dec. 24, 2020 (JP) 2020-214426

(51) Int. Cl. H01M 50/342; H01M 50/184

(52) U.S. Cl. CPC H01M 50/3425; H01M 50/184

(57) ABSTRACT

A film type battery is provided in which the film exterior body can be stably cleaved, thereby relaxing the internal pressure when the internal pressure of the film exterior body has increased to a prescribed value. The present disclosure provides a film type battery including a film exterior body, an electrode body accommodated in the inside of the film exterior body, a sheet-shaped terminal whose one end is extended to the outside of the film exterior body, a sealed part provided at the edge on the side of the film exterior body from which at least the terminal is extended, and a sealant film integrated with the terminal, and welded to the film exterior body at the sealed part. The sealant film includes a notch part formed such that the width in the direction of extension of the terminal of the sealed part is narrower than at other portions.

### CROSS REFERENCE TO RELATED APPLICATIONS

The present application claims the priority based on Japanese Patent Application No. 2020-214426 filed on Dec. 24, 2020, the entire contents of which are incorporated by reference in the present specification.

### BACKGROUND

The present disclosure relates to a film-type battery.

Conventionally, a film-type battery has been known in which an electrode body is accommodated in a film-shaped exterior member (which will be hereinafter referred to as a film exterior body). As the related art technology literatures relating to a film-type battery, mention may be made of Japanese Patent Application Publication No. 2001-93483, Japanese Patent Application Publication No. 2016-4731, and Japanese Patent Application Publication No. 2015-103291. For constructing such a film-type battery, for example, with an electrode body sandwiched between a pair of resin films, the peripheries of the opposing resin films are sealed, thereby making the film exterior body into a bag shape.

Japanese Patent Application Publication No. 2001-93483 discloses that a notch-shaped portion is provided at the sealed part formed at the periphery of the resin film such that the seal width is narrower than at other portions. With the film-type battery of Japanese Patent Application Publication No. 2001-93483, when the internal pressure of the film-type battery is increased due to the internal short circuit, or the like, the internal pressure is concentrated to the notch-shaped portion, such that seal of the portion is released. As a result of this, the film exterior body is cleaved, such that the internal pressure is relaxed, thereby avoiding the rupture thereof.

### SUMMARY

In Japanese Patent Application Publication No. 2001-93483, the internal pressure for cleaving the film exterior body is controlled by the seal width of the resin film. However, according to the study by the present inventors, for example, when a resin film is sealed using a heat bar being heated, the circumference of the pressed surface is also heated, and tends to be sealed together. For this reason, it is difficult to control the notch-shaped portion with a target seal width. Therefore, the seal width of the notch-shaped portion is not stabilized, such that the internal pressure for cleaving the film exterior body may largely include variation.

The present disclosure was completed in view of such circumstances. It is an object of the present disclosure to provide a film-type battery capable of stably cleaving the film exterior body, and relaxing the internal pressure when the internal pressure of the film exterior body increases to a prescribed value.

The present disclosure provides a film-type battery, including: a film exterior body; an electrode body accommodated in an inside of the film exterior body, and including an electrode; a sheet-shaped terminal electrically connected at one end thereof to the electrode, and extended at the other end thereof to an outside of the film exterior body; a sealed part provided at an edge of the film exterior body on the side thereof from which at least the terminal is extended; and a sealant film integrated with a surface of the terminal on a side thereof opposed to the film exterior body, and welded to the film exterior body at the sealed part. The sealant film includes a notch part formed such that a width in a direction of extension of the terminal of the sealed part is narrower than at other portions.

The provision of a notch part in a sealant film stabilizes the seal width of the notch part as compared with the case where a notch-shaped portion is provided at the sealed part between resin films as in, for example, Japanese Patent Application Publication No. 2001-93483. Therefore, when the internal pressure of the film exterior body increases to a prescribed value, with the notch part as a starting point, the film exterior body can be stably cleaved, thereby relaxing the internal pressure.

In accordance with one preferable aspect of the film-type battery herein disclosed, the electrode includes an electrode collector, and the terminal includes a cladding material including a first metal of the same kind as that of the electrode collector, and a second metal different from the first metal joined to each other therein. The sealant film is arranged so as to cover junction part between the first metal and the second metal. With the cladding material, the first metal and the second metal are joined to each other, and are interatomically bonded. By using such a cladding material, the resistance can be reduced, thereby improving the battery performances. Further, by covering the junction part with a sealant film, it is possible to preferably prevent the junction part (junction interface) from being exposed to the outside air or an electrolyte. Therefore, the terminal becomes less likely to be corroded (e.g., electrolytically corroded), such that the durability can be improved.

In accordance with another preferable aspect of the film-type battery herein disclosed, the terminal includes a cladding material including copper or a copper alloy, and a different metal from the copper or the copper alloy joined therein, and a nickel plating layer is provided on the surface of the portion of the copper or the copper alloy. As a result of this, elution of copper can be suppressed. Further, the adhesion with the sealant film is enhanced, such that the sealant film becomes less likely to be released from the surface of the terminal. Therefore, the sealability and the durability can be improved.

In accordance with a still other preferable aspect of the film-type battery herein disclosed, the notch part is formed such that the width gradually decreases from the inner edge toward the outer edge of the sealed part. As a result of this, when the internal pressure of the film exterior body increases to a prescribed value, the film exterior body can be gently cleaved, thereby relaxing the internal pressure.

### BRIEF DESCRIPTION OF THE DRAWINGS

FIG. 1 is a partially broken plan view schematically showing a film-type battery in accordance with one embodiment;

FIG. 2 is a cross sectional view along line II-II of FIG. 1; and

FIG. 3 is a view corresponding to FIG. 1 schematically showing a film-type battery in accordance with modified example.

### DETAILED DESCRIPTION

Below, appropriately referring the accompanying drawings, preferable embodiments of the technology herein disclosed will be described. Incidentally, matters necessary for executing the present disclosure, except for matters specifically referred to in the present specification (e.g., a general configuration and a constructing process of a battery module) can be grasped as design matters of those skilled in the art based on the related art in the present field. The technology herein disclosed can be executed based on the contents disclosed in the present specification, and the technical common sense in the present field. Further, in the following drawings, the members/parts producing the same action are given the same numeral and sign, and an overlapping description thereon may be omitted or simplified.

Incidentally, in the present specification, the term “film-type battery” denotes a battery configured such that an electrode body is accommodated in the inside of a film (sheet)-shaped exterior member in general. Further, in the present specification, the term “battery” is a term denoting an electric storage device capable of extracting the electric energy in general, and is a concept including a primary battery and a secondary battery. Further, in the present specification, the term “secondary battery” is a term denoting an electric storage device capable of repeatedly charging and discharging in general, and a concept including a so-called storage battery (chemical battery) such as a lithium ion secondary battery or a nickel hydrogen battery, and a capacitor (physical battery) such as an electric double layer capacitor.

Film-Type Battery 100

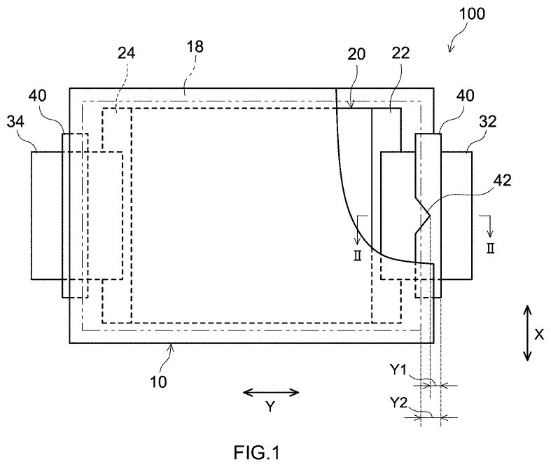

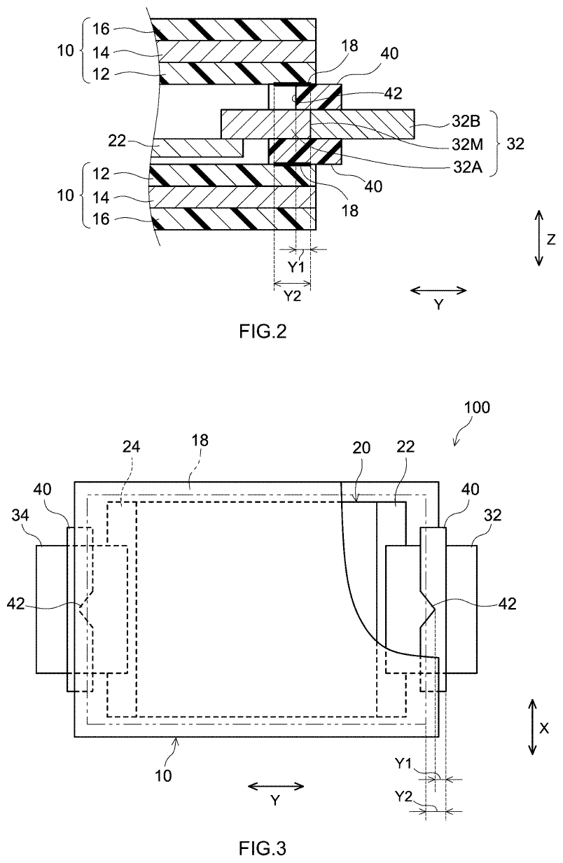

FIG. 1 is a partially broken plan view schematically showing a film-type battery 100. FIG. 2 is a cross sectional view along line II-II of FIG. 1. The film-type battery 100 includes a film exterior body 10, an electrode body 20, a positive electrode terminal 32, a negative electrode terminal 34 and an electrolyte (not shown). The film-type battery 100 is herein a lithium ion secondary battery. The positive electrode terminal 32 and the negative electrode terminal 34 are each one example of the terminal. Incidentally, in the following description, reference signs X, Y, Z in the drawings represent the short side direction, the long side direction orthogonal to the short side direction, and the thickness direction of the film-type battery 100, respectively. The long side direction is one example of the direction of extension of the positive electrode terminal 32 and the negative electrode terminal 34. However, these are merely the directions for convenience of description, and should not be construed as limiting the arrangement form of the film-type battery 100 at all.

The film exterior body 10 is a container for accommodating the electrode body 20 and the electrolyte therein. The film exterior body 10 has an insulation property, and the resistance to the electrolyte used. For the film exterior body 10, herein, in order to enable heat welding, at least the inner surface (the surface on the side opposed to the electrode body 20) includes a resin layer. The film exterior body 10 may be of a monolayered structure including one resin layer, or may be of a multilayered structure including two or more resin layers. The resin layer includes, for example, a thermoplastic resin such as a polyolefine resin, a polyester resin, a polystyrene resin, or a polyvinyl chloride resin. Examples of the polyolefine resin may include polyethylene (PE), polypropylene (PP), and acid modified polyolefine resins such as maleic anhydride modified polypropylene and maleic anhydride polyester. Examples of the polyester resin may include polyethylene terephthalate (PET). Further, between the resin layers, an adhesion layer for bonding the two resin layers to each other may be provided.

The film exterior body 10 is herein a so-called laminate film. The laminate film may be the same as that for use in, for example, a conventionally known laminate type battery, and has no particular restriction. As shown in FIG. 2, the film exterior body 10 includes a first resin layer 12, a metal layer 14, and a second resin layer 16 stacked in this order from the side closer to the electrode body 20.

The first resin layer 12 is a layer (sealant layer) for enabling heat welding. The first resin layer 12 includes, for example, the thermoplastic resin as described above. The first resin layer 12 is preferably a PP layer. The metal layer 14 is a layer for enhancing the air tightness. The metal layer 14 includes, for example, a metal material such as aluminum, iron, or stainless steel. The metal layer 14 is preferably an aluminum layer. The second resin layer 16 is a layer (protective layer) for enhancing the durability and the impact resistance. The second resin layer 16 includes, for example, the thermoplastic resin as described above. The second resin layer 16 is preferably a PET layer. The second resin layer 16 may form the surface layer (the outermost layer of the laminate film). Between the first resin layer 12 and the metal layer 14, an adhesion layer for bonding the two layers to each other may be provided. Further, on the second resin layer 16, another layer may be further provided.

The film exterior body 10 is herein formed in a bag shape by stacking two rectangular films one on another, and sealing the periphery thereof. As indicated with a dashed-and-double-dotted line in FIG. 1, a sealed part 18 is formed at the periphery of the film exterior body 10. The sealed part 18 seals the electrode body 20 and the electrolyte in the inside of the film exterior body 10 liquid-tightly.

The sealed parts 18 are herein formed each in a bag shape at the opposite ends in the short side direction X and at the opposite ends in the long side direction Y of the film exterior body 10, respectively. Although not shown, at the opposite ends in the short side direction X, the opposing film exterior bodies 10 are welded (e.g., heat welded). However, for example, when one film is folded in half for use, or a cylindrical film is used, or in other cases, the sealed part 18 is not required to be formed at one or both ends in the short side direction X. At the opposite ends in the long side direction Y, the film exterior body 10 and a sealant film 40 described later are welded(e.g., heat welded).

The configuration of the electrode body 20 may be the same as that of a conventionally known battery, and has no particular restriction. The electrode body 20 includes a sheet-shaped positive electrode (positive electrode sheet) and a sheet-shaped negative electrode (negative electrode sheet). As shown in FIG. 1, the electrode body 20 is herein a laminated electrode body including a quadrangular (typically, a rectangular) positive electrode sheet, and a quadrangular (typically, a rectangular) negative electrode sheet stacked one on another while being insulated from each other. However, the electrode body 20 may be, for example, a wound electrode body including a band-shaped positive electrode sheet and a band-shaped negative electrode sheet stacked one on another while being insulated from each other, and wound in the longitudinal direction. The positive electrode and the negative electrode are each one example of the electrode.

The positive electrode typically includes a positive electrode collector, and a positive electrode active material layer (not shown) fixed onto the positive electrode collector, and including a positive electrode active material. The positive electrode active material is, for example, a lithium transition metal composite oxide such as a lithium nickel cobalt manganese composite oxide. The positive electrode collector includes a conductive metal. The positive electrode collector includes, for example, a metal material such as aluminum, aluminum alloy, nickel, titanium, or stainless steel. The positive electrode collector is, herein, metal foil, specifically aluminum foil. The positive electrode collector is one example of the electrode collector. As shown in FIG. 1, the electrode body 20 includes a portion (positive electrode collector exposed part) 22 at which the positive electrode active material layer is not formed at one end (the right end of FIG. 1) in the long side direction Y. The positive electrode collector exposed part 22 is joined with the positive electrode terminal 32.

The negative electrode typically includes a negative electrode collector, and a negative electrode active material layer (not shown) fixed on the negative electrode collector, and including a negative electrode active material. The negative electrode active material is, for example, a carbon material such as graphite. The negative electrode collector typically includes a different conductive metal from that of the positive electrode collector. The negative electrode collector includes, for example, a metal material such as copper, a copper alloy, nickel, titanium, or stainless steel. The negative electrode collector is herein metal foil, specifically, copper foil. The negative electrode collector is one example of the electrode collector. As shown in FIG. 1, the electrode body 20 includes a portion (negative electrode collector exposed part) 24 at which the negative electrode active material layer is not formed at the other end (the left end of FIG. 1) in the long side direction Y. In the long side direction Y, the negative electrode collector exposed part 24 is herein arranged on the side opposite to the positive electrode collector exposed part 22. The negative electrode collector exposed part 24 is joined with the negative electrode terminal 34.

The electrolyte may be the same as that of a conventionally known battery, and has no particular restriction. The electrolyte is, for example, a nonaqueous electrolyte including a nonaqueous type solvent and a support salt. The nonaqueous type solvent includes, for example, carbonates. The support salt is, for example, a fluorine-containing lithium salt such as lithium hexafluorophosphate (LiPF₆). However, the electrolyte may be in a solid state (solid electrolyte), and may be integrated with the electrode body 20.

The positive electrode terminal 32 is arranged at one end (the right end of FIG. 1) in the long side direction Y. One end of the positive electrode terminal 32 is electrically connected with the positive electrode collector exposed part 22 in the inside of the film exterior body 10. The positive electrode terminal 32 extends along the long side direction Y. The other end of the positive electrode terminal 32 is extended to the outside of the film exterior body 10. As shown in FIG. 1, the positive electrode terminal 32 is a sheet-shaped metal member. The positive electrode terminal 32 is herein rectangular in a plan view.

The positive electrode terminal 32 may be the same as that for use in a conventionally known film-type battery, and has no particular restriction. The positive electrode terminal 32 may include one kind of metal, or may include two or more kinds of metals. The positive electrode terminal 32 may be made of, for example, aluminum or an aluminum alloy. For the positive electrode terminal 32, at least the end on the side to be connected with the positive electrode collector exposed part 22 preferably includes the same kind of metal as that of the positive electrode collector.

As shown in FIG. 2, the positive electrode terminal 32 herein includes a cladding material including a first metal 32A, and a second metal 32B of a different kind from that of the first metal 32A, joined and interatomically bonded to each other therein. Use of the cladding material can reduce the resistance and can improve the battery performances. For the positive electrode terminal 32, preferably, for example, the end (first metal 32A) on the side to be connected to the positive electrode collector exposed part 22 includes aluminum or an aluminum alloy, and the end (second metal 32B) on the side to be extended to the outside of the film exterior body 10 includes a different kind of metal such as copper or a copper alloy, or nickel or a nickel alloy.

A sealant film 40 is integrated with a part of the surface of the positive electrode terminal 32 on the side thereof opposed to the film exterior body 10. The sealant film 40 is typically welded to the surface of the positive electrode terminal 32 on the side thereof opposed to the film exterior body 10. However, the sealant film 40 may be pasted to the positive electrode terminal 32 using adhesive or the like.

The sealant film 40 covers the positive electrode terminal 32 so as to prevent the direct contact between the positive electrode collector exposed part 22 and the film exterior body 10. The sealant film 40 is welded (e.g., heat welded) to the film exterior body 10 opposed thereto. As a result of this, as shown in FIG. 1, at the edge of the film exterior body 10 on the side thereof from which the positive electrode terminal 32 is extended (the right side in the long side direction Y), the sealant film 40 is interposed between the positive electrode terminal 32 and the film exterior body 10, and a sealed part 18 is formed.

The sealant film 40 typically includes a resin material. It is essential only that the sealant film 40 has a resistance to the electrolyte to be used, and includes a resin material which is molten at a temperature comparable to that of the resin layer (e.g., the first resin layer 12) of the film exterior body 10. It is essential only that the sealant film 40 exhibits preferable adhesion to both the film exterior body 10 and the positive electrode terminal 32. Examples of the resin material forming the sealant film 40 may include the thermoplastic resins exemplified as those capable of forming the resin layer of the film exterior body 10. The sealant film 40 may be a monolayered structure including one resin layer, or may be a multilayered structure including two or more resin layers. The sealant film 40 may be a polyolefine film.

As shown in FIG. 1, the sealant film 40 is herein rectangular in a plan view. The sealant film 40 is provided along the edge on the side of the film exterior body 10 from which the positive electrode terminal 32 is extended (the right side of FIG. 1). The sealant film 40 extends in the short side direction X. In the short side direction X, the length of the sealant film 40 is longer than that of the positive electrode terminal 32. In the long side direction Y, the width of the sealant film 40 is equal to, or longer than that of the sealed part 18. One end of the sealant film 40 (the right end of FIG. 1) protrudes from the film exterior body 10.

As shown in FIG. 2, in the thickness direction Z, the sealant film 40 is interposed between the positive electrode terminal 32 and the film exterior body 10. The sealant films 40 are provided so as to sandwich the surfaces on the opposite sides of the positive electrode terminal 32 (the upper and lower surfaces of FIG. 2). The thickness (the length in the thickness direction Z) of the sealant film 40 may be smaller than the sheet thickness of the metal portion of the positive electrode terminal 32. The thickness of the sealant film 40 may be equal to, or larger than that of the positive electrode collector (metal foil). The sealant film 40 is herein provided so as to cover the junction part 32M between the first metal 32A and the second metal 32B. The junction part 32M is not exposed to the outside air and the electrolyte. As a result of this, it is possible to prevent the corrosion of the junction part 32M, and it is possible to improve the durability thereof

A notch part 42 is formed in the sealant film 40 integrated with one surface of the positive electrode terminal 32 (the upper surface in FIG. 2). The notch part 42 is a site serving as the starting point for cleaving the film exterior body 10 when the internal pressure of the film exterior body 10 increases to a prescribed value. As shown in FIG. 1, the notch part 42 is provided at the position overlapping the sealed part 18 in a plan view. The notch part 42 is provided such that the width in the long side direction Y of the sealed part 18 is narrower than at other portions. Provision of the notch part 42 in the sealant film 40 can stably cleave the film exterior body 10, and can relax the internal pressure when the internal pressure of the film exterior body 10 increases to a prescribed value. In the long side direction Y, the width Y1 of the narrowest portion of the notch part 42 may be ¼ to ¾ of each width Y2 of other portions of the sealed part 18. As a result of this, it is possible to improve the durability in normal use and the cleavability upon an increase in internal pressure with good balance.

Incidentally, the number, the shape, the size, and the like of the notch part 42 can be appropriately adjusted in consideration of, for example, the internal pressure under which the film exterior body 10 is desired to be cleaved. The number of the notch parts 42 may be one, or may be plural. The notch part 42 is herein formed such that the width in the long side direction Y gradually decreases from the inner edge toward the outer edge of the sealed part 18, in other words, as being apart from the electrode body 20. The notch part 42 is formed such that the width in the long side direction Y from the inner edge toward the outer edge of the sealed part 18 gradually decreases. The notch part 42 is herein triangular in a plan view. However, the shape of the notch part 42 has no particular restriction, and may be, for example, quadrangular or semicircular. As shown in FIG. 2, at the portion provided with the notch part 42, the positive electrode terminal 32 and the film exterior body 10 are apart from each other. In other words, the film exterior body 10 floats from the positive electrode terminal 32.

The negative electrode terminal 34 is arranged at the other end in the long side direction Y (the left end of FIG. 1). In the long side direction Y, the negative electrode terminal 34 is arranged on the side opposite to the positive electrode terminal 32. One end of the negative electrode terminal 34 is electrically connected with the negative electrode collector exposed part 24 in the inside of the film exterior body 10. The negative electrode terminal 34 extends along the long side direction Y. The other end of the negative electrode terminal 34 is extended to the outside of the film exterior body 10. As shown in FIG. 1, the negative electrode terminal 34 is a sheet-shaped metal member. The negative electrode terminal 34 is herein rectangular in a plan view.

The negative electrode terminal 34 may be the same as that for use in a conventionally known film-type battery, and has no particular restriction. The negative electrode terminal 34 may include one kind of metal or may include two or more kinds of metals. The negative electrode terminal 34 may be, for example, copper or a copper alloy. Further, on the surface of the portion formed of copper or a copper alloy, a plating layer coated with a metal such as nickel (e.g., a nickel plating layer) may be formed. As a result of this, it is possible to suppress elution of copper. Further, the adhesion with the sealant film 40 is enhanced, such that the sealant film 40 becomes less likely to be released from the surface of the negative electrode terminal 34. Therefore, the sealability and the durability can be improved. For the negative electrode terminal 34, at least the end on the side to be connected with the negative electrode collector exposed part 24 preferably includes the same kind of metal as that of the negative electrode collector.

The negative electrode terminal 34 preferably includes a cladding material. For example, preferably, the end on the side to be connected with the negative electrode collector exposed part 24 includes copper or a copper alloy, and the end on the side to be extended to the outside includes a different kind of metal such as aluminum or an aluminum alloy, or nickel or a nickel alloy.

The sealant film 40 is integrated with a part of the surface of the negative electrode terminal 34 on the side thereof opposed to the film exterior body 10 as with the positive electrode terminal 32. The sealant film 40 is welded (e.g., heat welded) with the film exterior body 10 opposed thereto. As a result of this, as shown in FIG. 1, at the edge of the film exterior body 10 on the side thereof from which the negative electrode terminal 34 is extended (the left side in the long side direction Y), the sealed part 18 is formed with the sealant film 40 interposed between the negative electrode terminal 34 and the film exterior body 10. Herein, the notch part 42 is not formed in the sealant film 40 of the negative electrode terminal 34. However, the notch part 42 may be formed in the sealant film 40 of the negative electrode terminal 34 as with the positive electrode terminal 32.

The film-type battery 100 is usable for various uses. For example, the film-type battery 100 can be preferably used as a high output power source for a motor (driving power supply) to be mounted on a car. The kind of the car has no particular restriction. Typically, examples thereof may include vehicles such as a plug-in hybrid electric vehicle (PHEV), a hybrid electric vehicle (HEV), and a battery electric vehicle (BEV).

Up to this point, specific examples of the present disclosure have been described in details. However, these are merely illustrative, and should not be construed as limiting the scope of the appended claims. The technology described in the appended claims includes various modifications and changes of the specific examples shown up to this point.

For example, in the foregoing embodiments, as shown in FIG. 1, the positive electrode terminal 32 extends from one end in the long side direction Y of the film exterior body 10, and the negative electrode terminal 34 extends from the other end in the long side direction Y. However, the present disclosure is not limited thereto. The positive electrode terminal 32 and the negative electrode terminal 34 may extend from the ends in the same direction of the film exterior body 10, for example, one end in the long side direction Y together. In that case, in a plan view, one sealant film 40 may be provided so as to cover the positive electrode terminal 32 and the negative electrode terminal 34.

For example, in the foregoing embodiments, as shown in FIG. 1, the sealant films 40 are integrated with the positive electrode terminal 32 and the negative electrode terminal 34, respectively. However, the present disclosure is not limited thereto. The sealant film 40 is not required to be integrated with the positive electrode terminal 32 or the negative electrode terminal 34. Further, the notch part 42 may be formed in only the sealant film 40 of the positive electrode terminal 32 or the negative electrode terminal 34. Alternatively, as shown in FIG. 3, the notch parts 42 may be formed in the sealant films 40 of the positive electrode terminal 32 and the negative electrode terminal 34, respectively. In that case, the shape, the size, and the like of the notch part 42 may be the same, or may be different between the sealant film 40 of the positive electrode terminal 32 and the sealant film 40 of the negative electrode terminal 34.

For example, in the foregoing embodiments, as shown in FIG. 2, the notch part 42 is provided only in the sealant film 40 on one surface in the thickness direction Z (the upper surface in FIG. 2). However, the present disclosure is not limited thereto. The notch parts 42 may be formed in the sealant films 40 on the surfaces on the opposite sides in the thickness direction Z (the upper and lower surfaces of FIG. 2), respectively. In that case, the shapes, the sizes, and the like of the notch parts 42 may be the same, or may be different between the surfaces on the opposite sides.

1. A film-type battery, comprising:
a film exterior body;
an electrode body accommodated in an inside of the film exterior body, and including an electrode;
a sheet-shaped terminal electrically connected at one end thereof to the electrode, and extended at the other end thereof to an outside of the film exterior body;
a sealed part provided at an edge of the film exterior body on a side thereof from which at least the terminal is extended; and
a sealant film integrated with a surface of the terminal on a side thereof opposed to the film exterior body, and welded to the film exterior body at the sealed part, wherein:
the sealant film includes a notch part formed such that a width in a direction of extension of the terminal of the sealed part is narrower than at other portions.

2. The film-type battery according to claim 1, wherein:
the electrode includes an electrode collector,
the terminal comprises a cladding material including a first metal of the same kind as that of the electrode collector, and a second metal different from the first metal, joined to each other therein, and
the sealant film is arranged so as to cover a junction part between the first metal and the second metal.

3. The film-type battery according to claim 1, wherein:
the terminal comprises a cladding material including copper or a copper alloy, and a different metal from the copper or the copper alloy, joined to each other therein, and
a nickel plating layer is provided on a surface of a part of the copper or the copper alloy.

4. The film-type battery according to claim 1, wherein:
the notch part is formed such that a width gradually decreases from an inner edge toward an outer edge of the sealed part.
